(19) United States
(12) Patent Application Publication
(10) Pub. No.: US 2007/0170672 A1
(43) Pub. Date: Jul. 26, 2007

(54) Storage apparatus

(76) Inventors: Roland O. Young, Grand Forks, ND (US); Larry P. Young, Grand Forks, ND (US)

Correspondence Address: ROBERT E. KLEVE, 1103-24TH AVE S., GRAND FORKS, ND, 58201, US

(21) Appl. No.: 10/930,403

(22) Filed: Aug. 31, 2004

(51) Int. Cl. B62B 1/00

(52) U.S. Cl. 280/47.28; 280/47.19

(57) ABSTRACT

The invention comprises a storage device for storing panel lift components disassembled which components include a leg support, telescoping means, a cradle for supporting a drywall panel with the telescoping means for telescoping the cradle, with the storing device having an upright pole to support the telescoping means upright, and engaging means to engage and secure the cradle and leg supporting means on the storage device, and with the storage device having wheels to move the device thereon from place to place. The storage device is capable of receiving and securely holding any of the drywall lift components together or independently while in a vertical or in a horizontal position as in transit, loaded on a vehicle.

This invention relates to a storage device for storing and transporting a panel lift apparatus.

It is an object of the invention to provide a novel storage apparatus for storing a disassembled panel lift apparatus when not in use.

It is another object of the invention to provide a novel compact storage device for storing a panel lift apparatus when the apparatus is not in use and which may be wheeled from its storage and transported from location to a location for the use of the panel lift apparatus.

Further objects and advantages of the invention will become apparent as the description proceeds when taken in conjunction with the accompanying drawings wherein

### BRIEF DESCRIPTION OF THE DRAWINGS

FIG. 1 is a front elevational view of the storage apparatus with none of the panel lift components attached to the apparatus.

FIG. 2 is a side elevational view of the storage apparatus with the legs component of the panel lift components in the process of being attached to the apparatus.

FIG. 3 is a fragmentary side view of the storage apparatus after the legs component has been attached to the storage device or apparatus.

FIG. 4 is a side elevational view of the storage device after the legs component and telescoping lift component of the panel lift device has been attached to the storage device.

FIG. 5 is an enlarged fragmentary side view of the upper side of the telescoping lift component and the latch for attaching the lift component to the storage apparatus.

FIG. 6 is an enlarged top fragmentary view of the top latch attached to the top of the telescoping lift component.

FIG. 7 is a front elevational view of the storage apparatus with the cradle component of the panel lift device attached to the storage device as well at the leg component.

FIG. 8 is an enlarged perspective view of the latch mechanism for holding the top of the cradle to the storage device.

FIG. 9 is a front elevational view of the storage device with the leg component, the cradle component and pair of lateral supports for the cradle attached to the storage apparatus,

FIG. 10 is a side view of the lever mechanism for disengaging the pair of lateral supports from the attachment to the storage device, illustrating the lever before being raised to disengage the pair of lateral supports.

FIG. 11 is a similar view to FIG. 10 illustrating the lever and lateral supports after the lever has been raised to disengage the lateral supports from the storage device.

FIG. 12 is a rear view of the storage apparatus.

FIG. 13 is a top view of the conventional cradle component of a panel lift device.

FIG. 14 is a top view of the center mounting portion of the conventional leg component of the panel lift device.

Briefly stated, the invention comprises a storage device for storing a conventional panel lift device. A conventional panel lift apparatus has a floor support, a telescoping member, a cradle mounted to the top of the telescoping member for supporting a panel and a pair of lateral supports for mounting to the cradle to laterally support the panel on the cradle. The storage device has a main two wheel base with an upright post and with lateral horizontal member intermediate the height of the post. The conventional floor support is mounted between the base and lateral horizontal member of the storage device, while the telescoping member is mounted beside the upright post and the cradle is mounted along the side of the upright post while the lateral supports are mounted to the intermediate horizontal member of the storage device opposite the mounting for the floor support.

### BRIEF DESCRIPTION OF PREFERRED EMBODIMENT

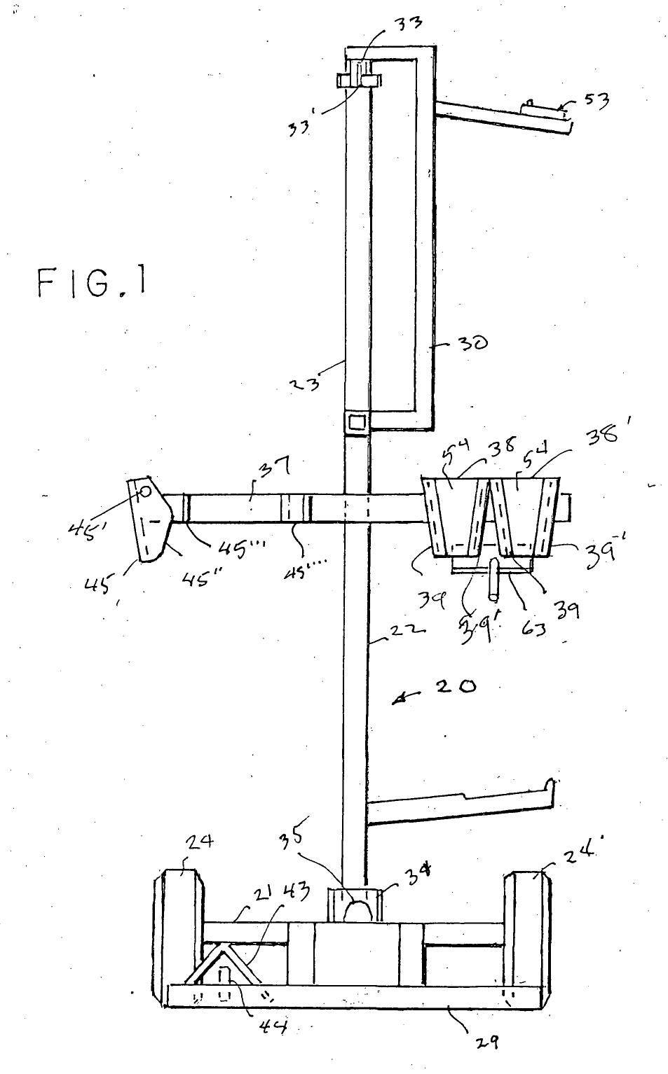

Referring more particularly to the drawings, in FIG. 1, the storage device 20 is illustrated with none of the components of the panel lift device attached to the device. The storage device 20 has a base 21 with a main upright pole 22. The pole 22 has a curved portion 23 at the upper end. The base 21 has a pair of wheels 24 and 24′ rotatably mounted to the base 21 to rotatably support the storage device 20 so that it may roll along a ground surface.

A conventional panel lift device for storing on the storage device 20, customarily, is of a construction well known in the art. A conventional panel lift device customarily has five components: a floor support 25, a telescoping sleeve apparatus 26, a cradle 27, and a pair of lateral braces 28 and 28′. The conventional device, when assembled, has the telescoping sleeve apparatus mounted upright on a panel base 25′ of the floor support 25 with and the cradle 27 mounted to the top of the telescoping sleeve 26 for supporting a drywall panel, with the telescoping sleeve having components manually telescoping the sleeves of the sleeve apparatus to telescope the cradle 27 with the drywall thereon upward and downward. The lateral brace members 28 and 28′ are customarily mounted laterally across opposite ends of the cradle 27 to provide lateral support to the drywall panel on the cradle.

The forward end of the base 21 of the storage device 20 has a horizontal pipe like support 29 to provide a front floor support for the storage device, with the pair of wheels 24 and 24′ rotatably mounted to the rear of the base 21 to provide a rear rolling support for the storage device.

The upright post or pole 22 of the storage device is fixed to the base 21 of the storage device 20 and extends upward with a semi circular member 23 fixed to the upper portion 31′ of the post, and with a side pole 30 fixed to the main pole 22 and extending upward where it joins the semi circular member 23. At the top of the semi circular member 23 is a pivotally mounted latch 33 which has one end 33″ pivotally mounted to the top of the semi circular member 23.

Mounted to the top 32 of the base 21 of the storage device 20 is a V shaped plate 34 with a curved pointed member 35 fixed to the top 29, adjacent to V shaped plate 34 and spaced inside the V shaped plate.

The conventional telescoping sleeve apparatus 26 of a conventional panel lift device, which acts to lift the cradle 27 of the conventional panel lift device, has a V shaped column 26′ along the front side of the outermost sleeve 30 with two telescoping sleeves 30′ and 30″ mounted inside the outer sleeve 30 to telescope upward out of the sleeve 26′ to raise the cradle 27

When attaching the telescoping sleeve component 26 to the storage device 20, the telescoping sleeve is placed so the bottom 26″ of the V shaped column 26′ is received between the V shaped plate 34 and pointed member 35 of the base of the storage device, when mounting the bottom of the telescoping member 26 of a panel lift device to the storage device 20.

The top of the V shaped column 26′ of a panel lift device is thereafter engaged against the diverging flanges 36 and 36′ fixed to the top of the semi circular member 23 of the storage device 20, when mounting the top of the telescoping member 26 of the panel lift to the semi circular member at the top of the storage device 20.

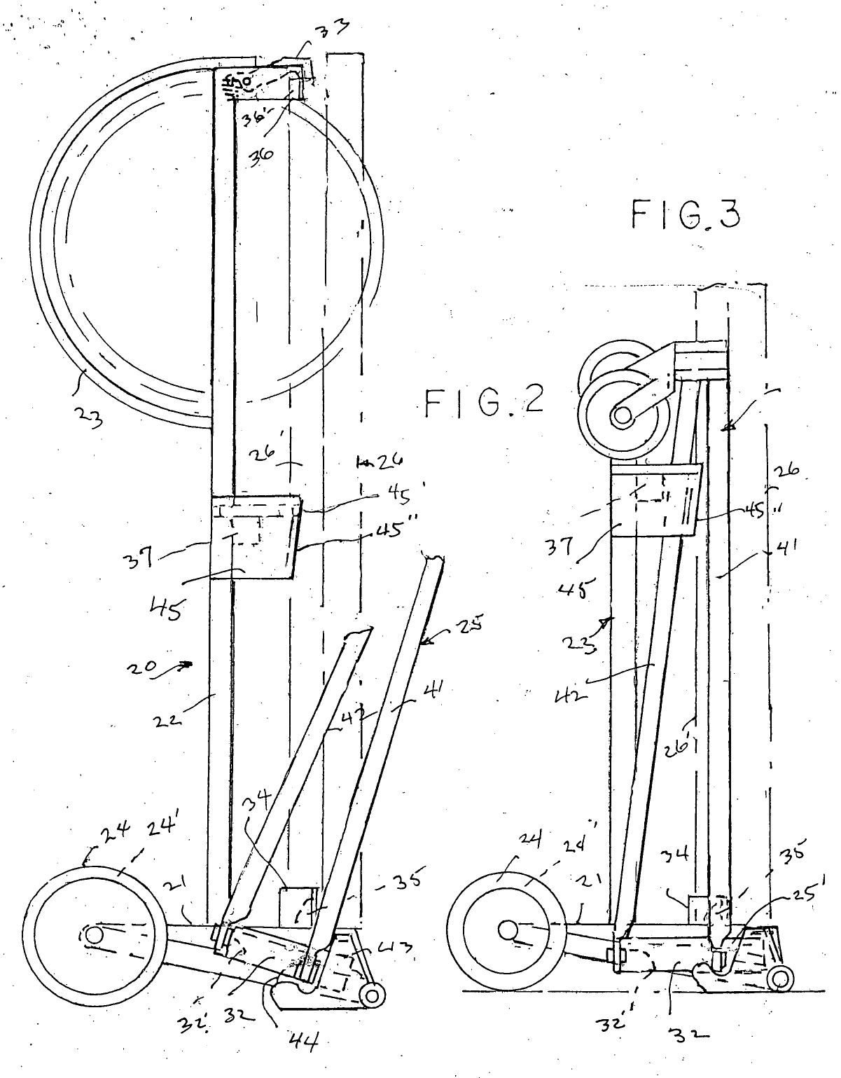

The latch 33 is pivotally mounted to the top of the semi circular member of the storage device about pivot 65. The latch 33 has a downwardly pointed end member 33′ which is spring loaded downwardly by a spring 33′″ at the opposite end of the latch. The latch has a projection 64 at its opposite end with the spring 33′″ surrounding the projection and with the spring engaging the floor 64 to which the latch is pivotally mounted so that the spring urges the pointed end 33′ of the latch downward as shown in the drawing. The latch may be manually lifted counter clockwise upward about its pivot 65, as viewed from FIG. 5 in opposition to its spring 33′″ urging and then released to allow the pointed end 33′ of the latch to be urged clockwise downward by the spring to engage downward past the top edge 26″ of the V shaped column 26′ of the panel lift device as illustrated in FIGS. 2,4,5, and 6 until its tip 33″″ engages the top edge 26″ to thereby hold and lock the top of the conventional telescoping sleeve 26′ to the top of the storage device 20. Thus, the telescoping sleeve component 26 of a conventional panel lift device is thereby fixedly attached to the storage device 20 as shown in FIGS. 2,4,5,6 and 9.

The horizontal bar or horizontal post 37 is fixed to the upright post 22 of the storage device, intermediate the height of the post 22 of the storage device. The horizontal post 37 extends horizontally to each side of the post. On one side 37′ of the horizontal post are a pair of frusto conical channel plates 38 and 38′ each having downward and inward converging channel portions 39 and 39′ along their outer edges.

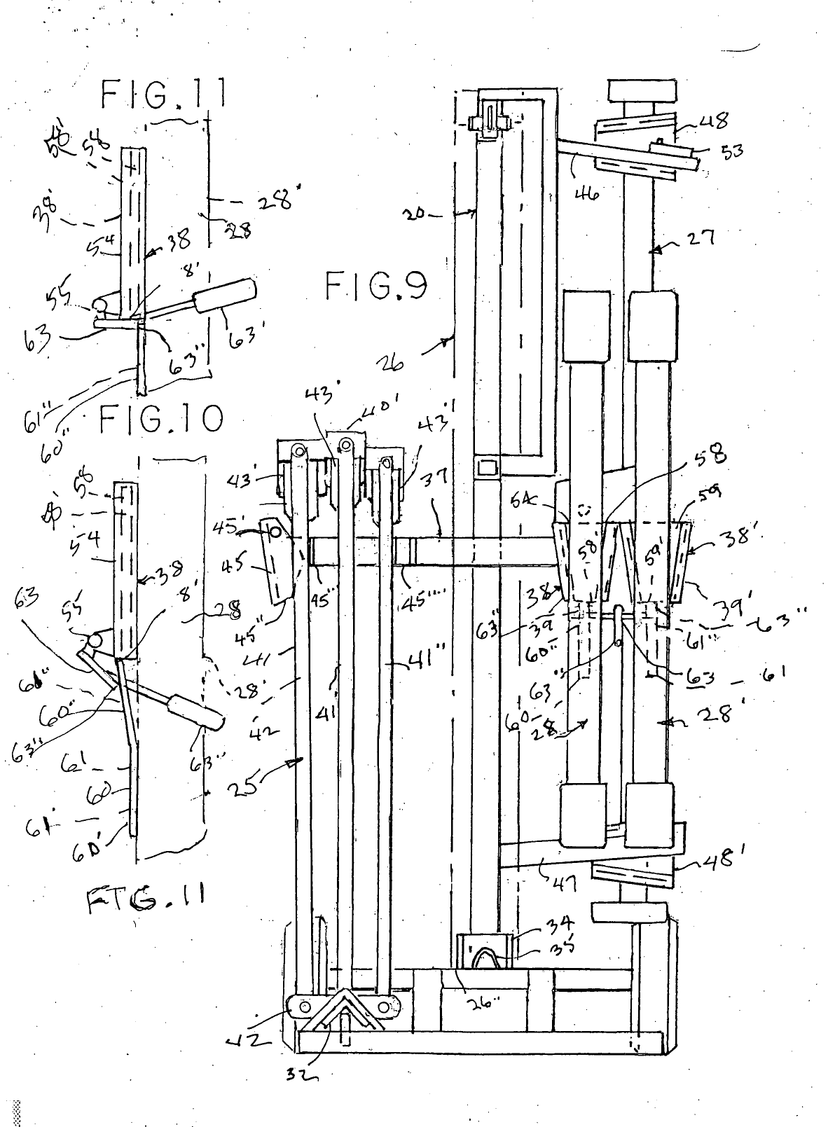

To attach the lateral brace members 28 and 28′ of the conventional panel lift device to the storage device 20, the brace members are attached and stored on the conical plates 38 and 38′ on the horizontal post 37 of the storage device. Each brace member 28 and 28′ has a frusto conical plate 58 and 59, which when the panel lift device is assembled fit into the frusto conical plates with channels 48 and 48′ of the cradle. The frusto conical plates 58 and 59 of the brace members are adapted to be slide downward into the channel portions 39 and 39′ of the channels 38 and 38′ pf the storage device to their positions, as shown in FIG. 9, to support the pair of lateral support member 28 and 28′ on the storage device.

The floor support tripod 25 of a conventional panel lift device has three arms outer 41, center 41′, and outer 41″ which are pivotally mounted to a center support 42. The center support has a v shaped flange 32 with a pointed flange 32′, which receives the bottom of the V shaped column 26′ of the telescoping sleeve when assembling the panel lift device.

Each arm of the floor support has a rotatable wheel 43′ mounted to their our ends. The three arms 41, 41′, and 41″ of the floor support are pivotally moved outward radially to 120 degree spacing between them when using the floor support to support telescoping sleeve with the cradle thereon and lateral support components of the panel lift device.

The V shaped flange 32 and point flange 32′ of the floor support is similar to the storage V shaped flange 34 and pointed member 35 on the base 21 of the storage device, and which also receives the bottom of the V shaped column 26′ of the telescoping sleeve in a similar manner when storing the telescoping sleeve 26.

The legs of the floor support 25 of the conventional panel lift are adapted to be attached to the other side 37″ of the horizontal post 37 of the storage device, opposite the mounting location of the with the other side 37′ of the post adapted to receive the lateral braces 28 and 28′ of the conventional panel lift device.

On the base 21 of the storage device is a V shaped cover 43, which is fixed to a horizontal bar 29 fixed at the front of the base 21 of the storage device. Beneath the cover 43 is an upright flange 44.

To attach the floor support 25 to the storage device for storage, the center support 32 of the floor support of the panel lift device is lowered and the end of the V shaped flange 32 is inserted beneath the V shaped cover and placed on the upright flange 44 in its position as generally shown in FIG. 2, with the V shaped flange 32 of the center support resting on the upright plate 44 of the storage device. The floor support will then be pivoted upward by pivoting the V flange 32 of the center support 42 of the floor support from its position shown in FIG. 2 to its position shown in FIG. 3 with V flange 32 of the center support 42 in beneath the V cover 43 of the storage device, with the V flange 32 of the center support 42 inside of the V of the floor support and remaining resting on an upright plate 44 fixed to the base of the storage device, beneath the V of the storage device. The floor support of the panel lift device will be pivoted upward to its position shown in FIG. 3 where it reaches the pivoting leg latch cover 45 mounted on the horizontal post 37 of the storage device.

The pivoting cover 45 on the horizontal post 27 will be pivoted outward about its horizontal axis 45′ relative to the post 37 to allow the legs of the floor support to be pivoted onward rearward toward and against the horizontal post 37 to a vertical position as shown in FIG. 3.

Whereupon, the pivoting cover will be released and it is spring loaded to pivot counterclockwise laterally toward and against the brace 42 of the leg or arm 41 of the floor support to allow thea lateral front edge 45″ to engage around and in front against the front of the brace 42 of leg 41 as shown in FIG. 3 to hold the brace 42 and thereby hold the leg 41 of the floor support rearward against the horizontal post of the storage device, to thereby hold the floor support to the storage device as shown in FIG. 3.

A projecting plate 45′″ is fixed to the bar or post 37 on the opposite side of brace 42 and projects forward to prevent any lateral movement of the brace 42 of the leg 41 laterally away from the cover toward the center post of the storage device. The pivoting plate 45, together with the projecting plate 45′″ act to lock the brace 42 of the leg 41 to the post 37. A second projecting plate 45″″ is fixed to the horizontal post 37 closer to the center post to prevent the leg 41″ of the floor support from moving toward the center post of the storage device.

An upper horizontal post 46 and lower horizontal post 47 are fixed to the main vertical post 31 of the storage device and extend horizontally outward. The posts 46 and 47 of the storage device are used to attach and support the main cradle 27 of a conventional panel lift device.

The main cradle 27 of a conventional panel lift device has a pair of tapered channel members 48 and 48′. Each channel member has confronting channels 49 and 49′ at the edges of a main plate portion 50 for receiving the frusto-conical shaped plates 58 and 59 of the lateral supports on a conventional panel lift device when operating and assembling the panel lift device.

When storing the cradle 27, the lower post 47 on the storage device has a slot 52 to receive the channel 48′ on the lower channel member of the cradle.

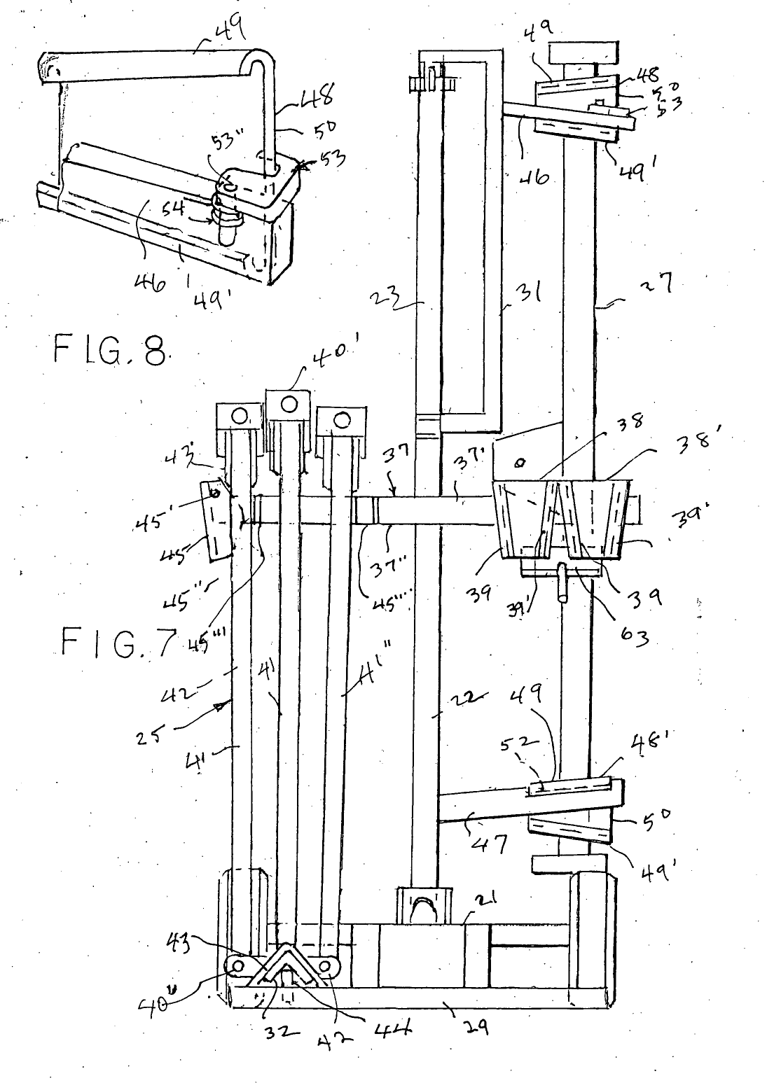

The upper post on the storage device has a lever 53 pivotally mounted to the upper post about axis 53′, and spring urged by spring 54 to pivot counterclockwise its hook end 53′″ pivoting rearward to engage about the edge of the main plate portion 50 of channel 48, when viewed from FIG. 8 and as shown.

When storing the cradle 27 on the storage device, the channel 49 of the channel 48′, at the lower end of the cradle, will first be fitted into the slot 52 on the lower post 47 of the storage device, and the upper end of the cradle will then be pivoted toward the upper end of the semi circular portion of the storage device until the upper channel 49′ of the upper channel member 48 rests against the slanted bottom of the upper post 46.

Whereupon, the lever 53 will be released and guided and urged by the spring 54 to pivotally move about the edge of the portion 50 of channel 48 to lock the upper end of the cradle 27 to the storage device as shown in FIG. 8.

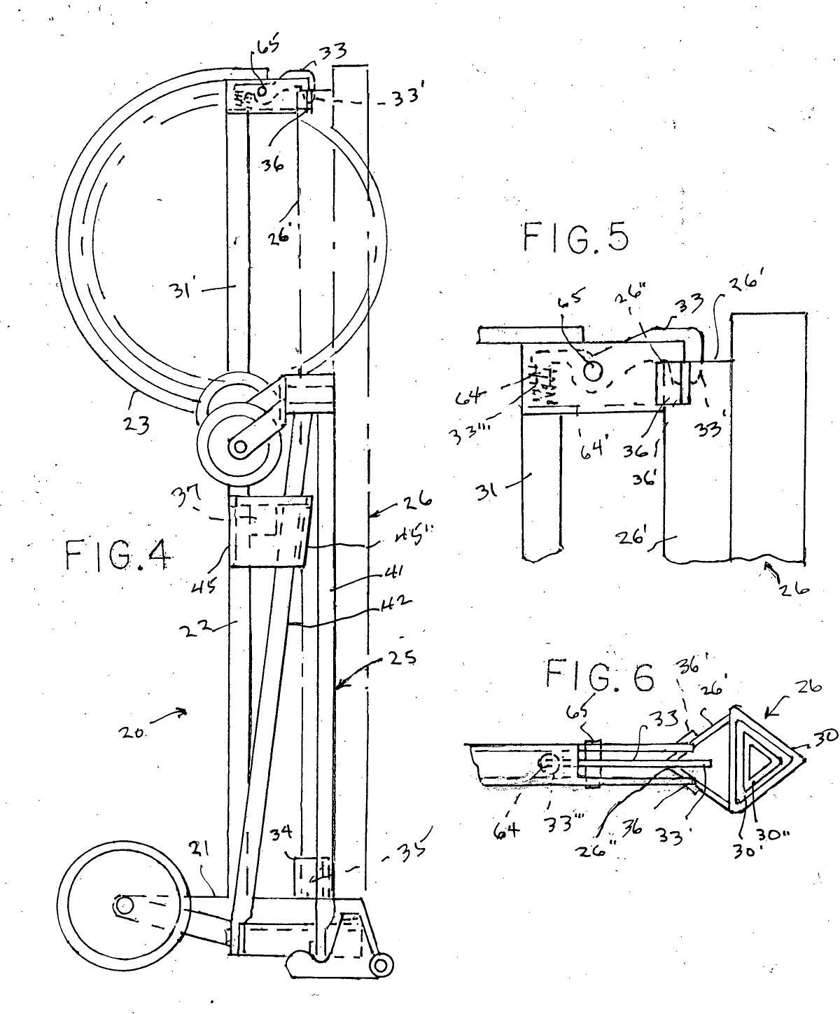

The pair of channel members 38 and 38′ of the storage device, which are fixed to the other side 60 of the horizontal post 37 and as indicated previously, act to receive the frusto conical plates 58 and 59 on the lateral supports 28 and 28′ of the panel lift device by sliding the plates down into the channel members as shown in FIG. 4.

The lateral supports 28 and 28′ of a conventional panel lift device are customarily constructed with spring metal strips or straps 60 and 61, respectively. The straps each have their lower one ends 60′ and 61′, respectively, fixed to their respective lateral support and their other upper ends 60″ and 61″ preformed to spring out away to the left from their respective support to their position, as shown in FIG. 10. The spring straps 60 and 60′ are shown their normal position in FIG. 10.

When the lateral supports are mounted to the channel members 38 and 38′ of the storage device, as shown in FIG. 9; the tops 60″ and 61″ of the spring straps or strips 60 and 60′ engage the bottom edge 58′ and 59′ of the channel members 38 and 38′ and thereby lock the lateral supports to the channel members 38 and 38′ and prevent their upward removal from the channel members 38 and 38′ and serve as a locking mechanism to lock the lateral supports to the channels of the storage device.

The spring straps similarly serve, when the lateral supports are mounted to the channel members of the cradle of a conventional panel lift device, to lock the lateral supports to the cradle by their upper ends 60″ and 61 ″ of the straps engaging the lower edge 62 and 62′ of the channel members 48 and 48′ to prevent the straps 60 and 61 of the lateral braces 28 and 28′ from sliding out of the channel members 48 and 48′ of the cradle, thereby preventing the frusto conical plates 58 and 59 on the lateral supports 28 and 28′ from sliding out of the channel members 48 and 48′ of the panel lift device.

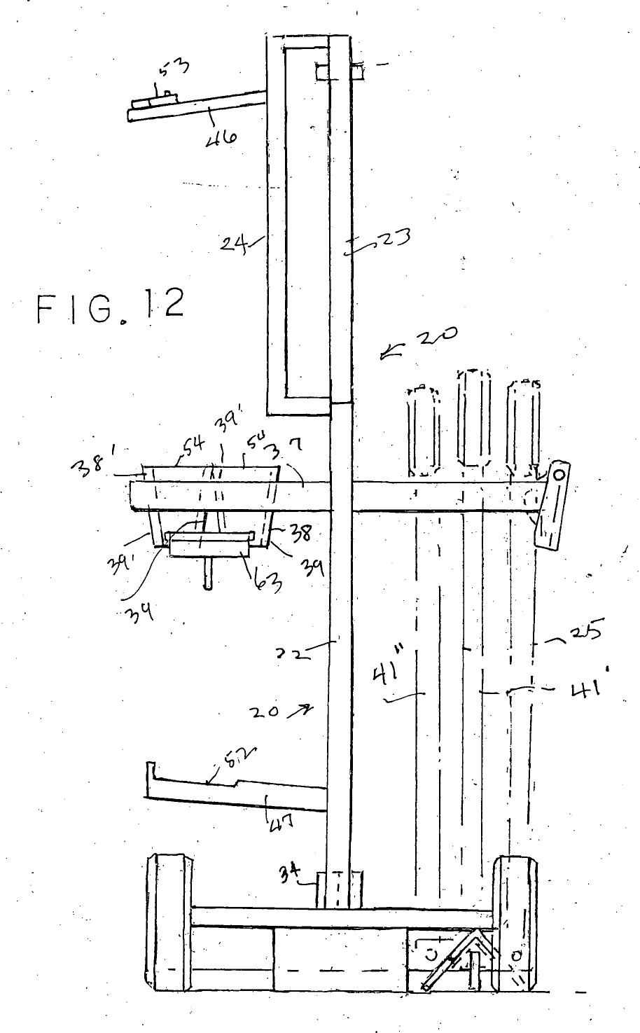

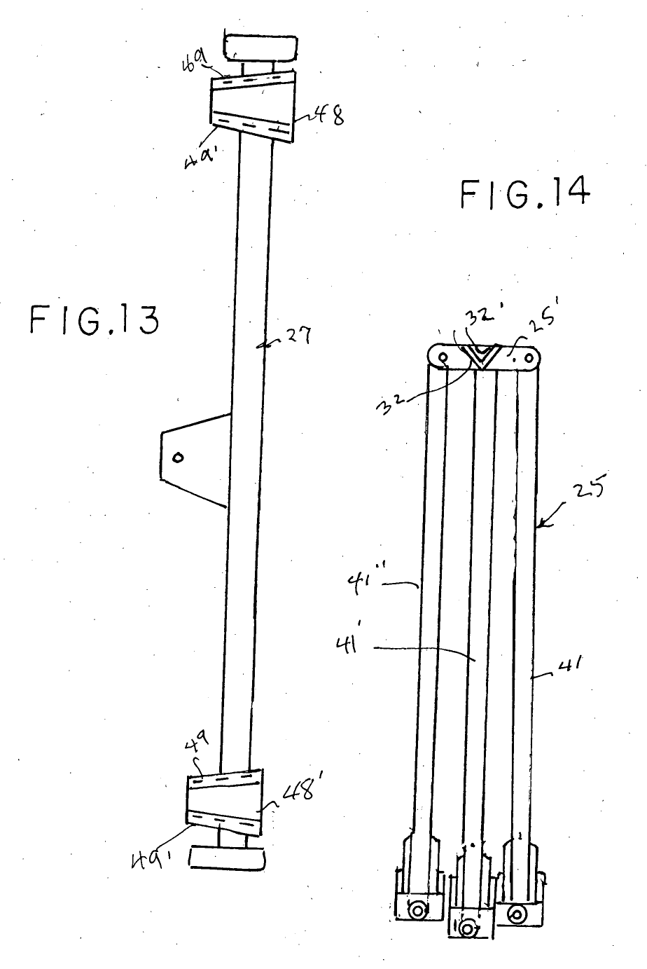

A pivotally mounted plate 63 is pivotally mounted to the channel members 38 and 38′ on the storage device to pivot about a horizontal axis 55 and has a handle 63″ to grasp to pivot the plate 63 upward relative to the channel members 38 and 38′ to cause the plate 63 at its forward edge 63″ to engage against the spring metal straps engage against back side of the of the upper portions 60″ and 61″ of spring metal straps 60 and 61 to urge them to the right when viewed from FIGS. 10 and 11 to move the top edges 60″ and 61″ of the straps away from the bottom edges 58′ and 59′ of the channel members 38 and 38′ as shown in FIG. 10 to their position shown in FIG. 11. The straps or strips in their position as shown in FIG. 11 will now clear the back plate portion 54 of the channel members 38 and 38′ and straps may slide upward, with the lateral supports 28 and 28′ and the plates 58 and 59 of the lateral supports, up, past the past the back plate portion 54 of channel members 38 and 38′, and out of the channel members 38 and 38′ of the storage device.

The releasing of the handle 63′ will allow the spring straps to spring back to their normal position shown in FIG. 10, which when the lateral supports are mounted in the channel members locks the lateral supports from being slid upward by its normal engagement against the bottom edge 58′ and 59′ of the channel members 38 and 38′ of the lateral supports.

The storage device is constructed so that five components of the panel lift device, namely the telescoping sleeve mechanism 26, the leg support mechanism 40, the cradle 27, and the two lateral supports 28 and 28′ for the cradle may be removed or attached to the storage device in any desired order. The storage construction is such that none of the components interfere with one another so that none need to be attached or detached before the next component may be attached or detached. This enables easy removal or attachment of the components relative to the storage device.

Also, the storage device is provided with a positive locking mechanism for each of the components so that the components will remain locked to the storage device is a relatively fixed position so as not be become disengaged or loose on the storage device, when the storage device is upright or when it is tilted or placed horizontal with semi circular strap serving a rear leg support for the device to engage the ground with the two wheels serving as a front support for the device.

Thus it will be seen that a novel storage device has been provided for quickly and easily storing a conventional panel lift device thereon when not in use and which can be a conveniently wheeled to and from storage to a location for use and which provided a means for rapidly detaching and removing the components from the storage device when it is desired to assemble and use the panel lift device.

It will be obvious that various changes and departures may be made to the invention without departing from the spirit and scope thereof; and accordingly, it is not intended that the invention be limited to that specifically described in the specification or as illustrated in the drawings, but only as set forth in the appended claims wherein:

What is claimed is:

1. A storage device for storing a panel lift apparatus, wherein the panel lift apparatus has components comprising a leg support, a cradle to hold a drywall panel, lateral supports for the cradle, telescoping means having means at one end to engage the leg support and means at it other end to engage the cradle to telescope the drywall panel on the cradle upward on the leg support with said panel lift components disassembled, said storage device comprising a base with rotatable wheel means providing a rolling support for the base upon a surface, main upright post mounted to the base, leg supporting storing means along one side of the upright post to support and store the leg support, cradle supporting storing means along the other side of the upright post to support the cradle of the panel lift, lateral support storing means mounted to the post to support the lateral supports of the panel lift, and means at the base of the storing device to engage the telescoping means at said one end and latch means the top of the upright post of the storage device to support the telescoping means at its said other end.

2. A storage device for storing a panel lift apparatus with the components disassembled, wherein the panel lift apparatus has components comprising a leg support, cradle means to hold a drywall panel, telescoping means having means at one end to engage the leg support and means at its other end to engage the cradle to telescope a cradle upward on the leg support, said storage device comprising base, ground supporting wheels on the base, means on the base of the storing device to engage and secure the telescoping means at said one end, said storage device having an upright post, means on and upper portion of the post to secure the telescoping means adjacent its other end, said storage device having means to secure the leg support and cradle means thereon whereby the storage device may be wheeled about on its wheels with the component of the panel lift device stored thereon disassembled.

3. A storage device for storing a panel lift components disassembled wherein the components include a leg support, telescoping means, a cradle for supporting a drywall panel with the telescoping means for telescoping the cradle, said storage device having an upright pole to support the telescoping means upright, engaging means to engage and secure the cradle and leg supporting means on the storage device, with the storage device having wheels to move the device thereon from place to place.

4. A storage device for storing a panel lift components disassembled according to claim 2 said storage device has separately independent storing mechanisms for each component whereby each component may be stored or removed from storage on the device in any succession or without the storage mechanisms for one component interfering with the storage of another of said components.

5. A storage device according to claim 4, wherein each storing mechanism is provided with a positive locking mechanism whereby the storage device may have an upright position or a generally horizontal position with the components remaining in a relatively unmovable locked fixed relation to one another and to the storage device.
